(19) United States
(12) Patent Application Publication
(10) Pub. No.: US 2021/0000683 A1
(43) Pub. Date: Jan. 7, 2021

(54) Percussive massage gun

(71) Applicant: Guomei Cheng, Nanjing (CN)

(72) Inventor: Guomei Cheng, Nanjing (CN)

(21) Appl. No.: 17/029,081

(22) Filed: Sep. 23, 2020

(51) Int. Cl. A61H 23/00; A61H 23/02

(52) U.S. Cl. CPC A61H 23/006; A61H 23/0254; A61H 2201/1215; A61H 2201/1418; A61H 2201/0157; A61H 2201/0165; A61H 2201/0153; A61H 2201/1635; A61H 2201/1454

(57) ABSTRACT

A massage gun includes a triangular handle chamber, a head chamber, and a ball-shaped components chamber formed between the handle and the head chamber; three rechargeable batteries in three parts of the handle chamber respectively; an electric motor in the components chamber; a cam on a motor shaft of the motor and including a main body and an eccentric, cylindrical rod; a linkage in the components chamber and including first and second holes; a first bearing on the cylindrical rod and inserted in the second hole; a second bearing in the first hole; a bearing seat in a joining portion of the components chamber and the head chamber; a bearing sleeve in the head chamber; a reciprocating sleeve engaged with the second bearing and put on the bearing sleeve; and a controller in the components chamber and electrically connected to the motor, the rechargeable batteries, and an on/off switch.

### BACKGROUND OF THE INVENTION

### 1. Field of the Invention

The invention relates to therapeutic devices and more particularly to a percussive massage gun having improved characteristics.

### 2. Description of Related Art

Percussive massage is a rapid, percussive tapping, slapping and cupping of an area of the human body. Percussive massage is used to strengthen deep-tissue muscles. Percussive massage increases local blood circulation and can even help tone muscle areas. Percussive massage may be applied by electromechanical percussive massage devices which may include an electric motor for driving a reciprocating piston within a cylinder. A variety of percussive heads may be attached to the piston to provide different percussive effects on selected areas of the body.

However, conventional personal massage devices often provide ineffective massages that are superficial and do not provide any real benefit.

There is a commercially available massage gun having a number of rechargeable batteries disposed in the handle. However, it greatly enlarges the handle. As a result, an individual may have great difficulties of holding the massage gun in a massaging operation.

Thus, the need for improvement still exists.

### SUMMARY OF THE INVENTION

The invention has been made in an effort to solve the problems of the conventional art including a bulky handle by providing a percussive massage gun having novel and nonobvious characteristics.

To achieve above and other objects of the invention, the invention provides a massage gun comprising a first shell; a second shell secured to the first shell for form a triangular handle chamber, a head chamber, and a ball-shaped components chamber formed between the handle and the head chamber; three rechargeable batteries disposed in three parts of the handle chamber respectively and electrically connected together; an electric motor disposed in the components chamber; a cam disposed on a motor shaft of the electric motor and including a main body and an eccentric, cylindrical rod extending out of the main body; a linkage disposed in the components chamber and including a first hole and a second hole; a first bearing disposed on the eccentric, cylindrical rod and further inserted in the second hole of the linkage; a second bearing disposed in the first hole of the linkage and being smaller than the first bearing; a bearing seat disposed in a joining portion of the components chamber and the head chamber; a bearing sleeve disposed in the head chamber; a reciprocating sleeve engaged with the second bearing and passing through the bearing seat to put on the bearing sleeve; an on/off switch disposed on an outer surface of the components chamber; and a controller disposed in the components chamber and wherein the controller is adjacent to the on/off switch and electrically connected to the electric motor, the rechargeable batteries, and the on/off switch.

Preferably, the parts of the handle chamber are curved.

Preferably, the components chamber comprises a charging socket electrically connected to the rechargeable batteries.

Preferably, the charging socket is USB Type-C.

Preferably, the components chamber comprises a flange configured to secure the electric motor to the second shell.

Preferably, a shock absorbing member sandwiched by the electric motor and the flange is further provided.

Preferably, the rechargeable batteries are electrically connected together in series.

Preferably, the first shell and the second shell are threadedly secured together.

Preferably, a plurality of limit bars in the component chamber and spaced from two sides of the linkage is further provided.

The invention has the following advantageous effects in comparison with the prior art: three rechargeable batteries are disposed in three parts of the handle chamber respectively so that sizes of the three parts can be decreased greatly, thereby facilitating a gripping of the handle chamber by the hand. An individual may hold the handle chamber or the component chamber with one hand or hold the handle chamber and the component chamber with two hands respectively in operation. Two bearings are mounted in the linkage. The bearings are operatively connected to both the cam and the reciprocating sleeve. Thus, friction is greatly decreased and in turn noise is greatly decreased in operation.

The above and other objects, features and advantages of the invention will become apparent from the following detailed description taken with the accompanying drawings.

### BRIEF DESCRIPTION OF THE DRAWINGS

FIG. 1 is a perspective view of a percussive massage gun according to the invention with the first shell removed;

FIG. 2 is a sectional view taken along line A-A of FIG. 1;

FIG. 3 is a side elevation of the cam; and

FIG. 4 is a top plan view of the linkage.

### DETAILED DESCRIPTION OF THE INVENTION

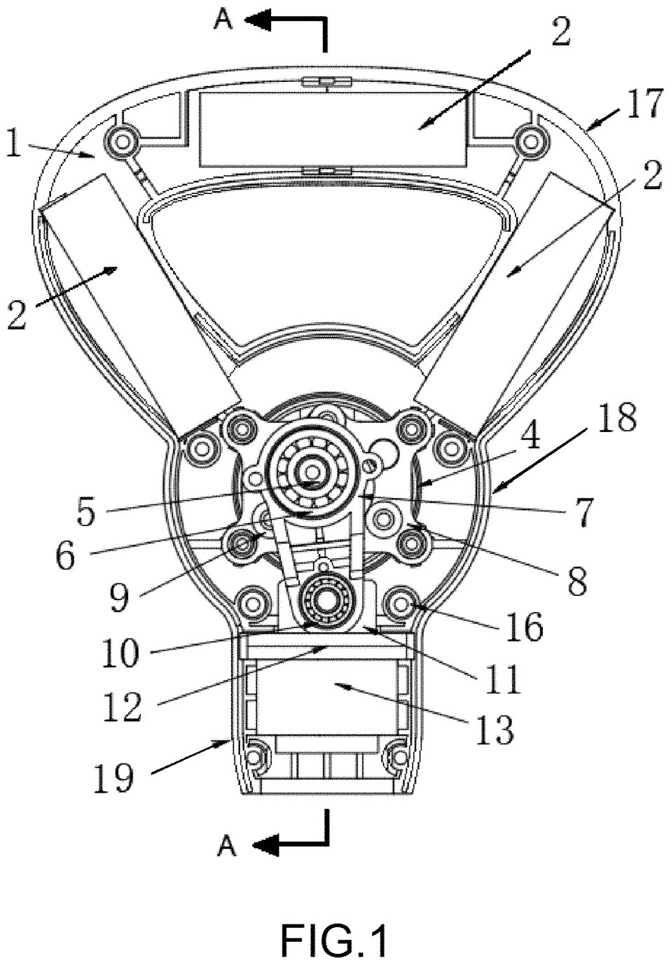

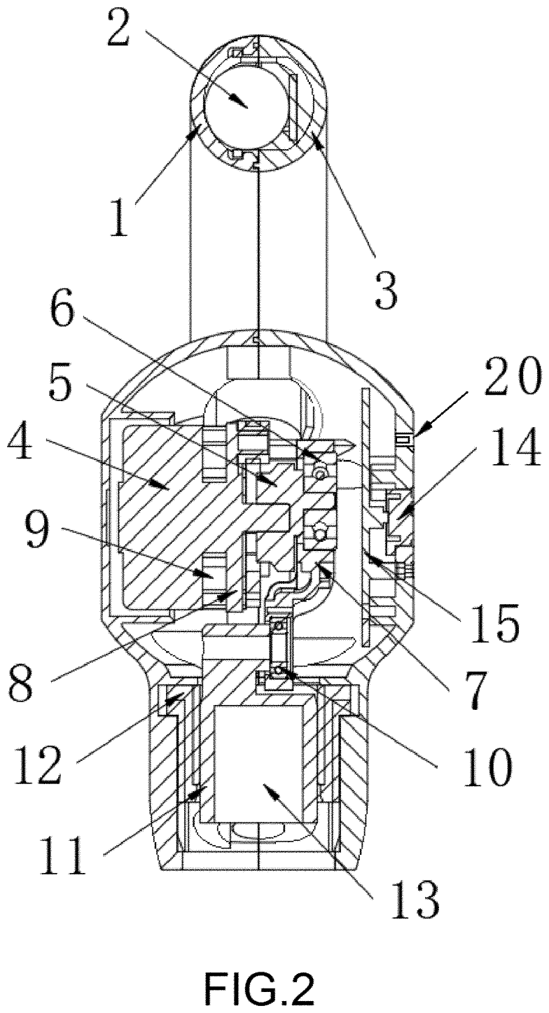

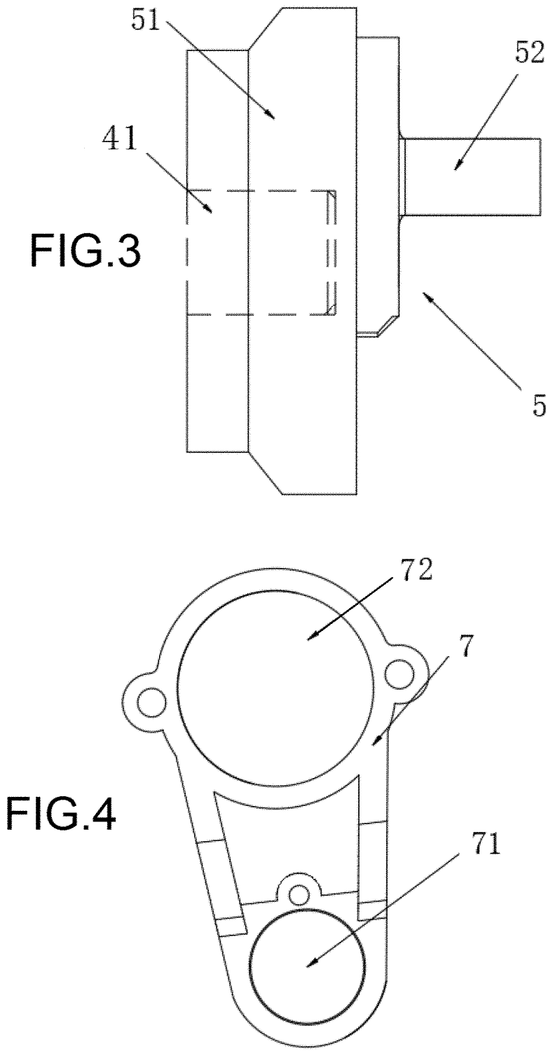

Referring to FIGS. 1 to 4, a percussive massage gun in accordance with the invention comprises a first shell 3, a second shell 1 threadedly secured to the first shell 3 to form a complete housing including a triangular handle chamber 17, a head chamber 19, a ball-shaped components chamber 18 formed between the handle 17 and the head chamber 19, three rechargeable batteries (e.g., 18650 lithium cells) 2 in three parts of the handle chamber 17 respectively and electrically connected together in series, an electric motor 4 in the components chamber 18, a cam 5 disposed on a motor shaft 41 of the electric motor 4 and including a main body 51 and an eccentric, cylindrical rod 52 extending out of the main body 51 in which a distance between the axis of the main body 51 and the axis of the cylindrical rod 52 are parallel each other and a distance between them is about 3 cm to 5 cm, a first bearing 6 disposed on the cylindrical rod 52, a linkage 7 including a first hole 71 with a second bearing 10 mounted therein and a second hole 72 with the first bearing 6 mounted therein in which the first bearing 6 is greater than the second bearing 10, a bearing seat 12 mounted in a joining portion of the components chamber 18 and the head chamber 19, a bearing sleeve 13 mounted in the head chamber 19, a reciprocating sleeve 11 engaged with the second bearing 10 and passing through the bearing seat 12 to put on the bearing sleeve 13, an on/off switch 14 mounted on an outer surface of the components chamber 18, and a controller 15 in the form of a printed circuit board (PCB) mounted in the components chamber 18 adjacent to the on/off switch 14. The electric motor 4 is electrically connected to the controller 15. Also, the controller 15, the rechargeable batteries 2, and the on/off switch 14 are electrically connected together.

Preferably, the handle chamber 17 has three curved parts to be easily gripped by the hand.

Preferably, a charging socket 20 is provided on the outer surface of the components chamber 18 so that mains electricity can be supplied to the rechargeable batteries 2 by inserting a plug in the charging socket 20.

Preferably, the charging socket 20 is USB Type-C and the charging socket 20 is the same type as a cellular phone. Thus, an adapter for a cellular phone is capable of charging the percussive massage gun.

Preferably, a flange 8 is provided in the components chamber 18 and is adapted to secure the electric motor 4 to the second shell 1. Thus, an assembly of the electric motor 4 is made easy.

Preferably, a shock absorbing member 9 is sandwiched by the electric motor 4 and the flange 8 to absorb shock generated by the electric motor 4 in operation.

Preferably, a plurality of limit bars 16 are provided in the components chamber 18 and spaced from both sides of the linkage 7, i.e., the linkage 7 spaced from both the second shell 1 and the first shell 3.

Assembly of the percussive massage fan is detailed below. The electric motor 4 is secured to the flange 8. The shock absorbing member 9 is sandwiched by the electric motor 4 and the flange 8. The flange 8 is secured to the second shell 1. Conductors are used to electrically connect the electric motor 4 to the controller 15. The rechargeable batteries 2 are mounted in the handle chamber 17. Another conductors are used to electrically connect the rechargeable batteries 2 to the on/off switch 14. The cam 5 is mounted on the motor shaft 41 of the electric motor 4. The first bearing 6 is mounted on the cylindrical rod 52 of the cam 5. The second bearing 10 is mounted in the first hole 71 of the linkage 7. The second bearing 10 is mounted in the first hole 71 of the linkage 7. The first bearing 6 is mounted in the second hole 72 of the linkage 7. Finally, the reciprocating sleeve 11 is mounted to engage with the second bearing 10 and has one end passing through the bearing seat 12 to put on the bearing sleeve 13.

Operation of the percussive massage fan is detailed below. The on/off switch 14 is turned on to electrically activate the electric motor 4. The motor rotor 41 rotates to rotate the cam 5 which in turn rotates the first bearing 6 around the motor shaft 41 of the electric motor 4. The first bearing 6 causes the linkage 7 to oscillate. And in turn, the linkage 7 causes the second bearing 10 to oscillate. And in turn, the second bearing 10 causes the reciprocating sleeve 11 to oscillate. The movement of the reciprocating sleeve 11 from side to side is limited because the reciprocating sleeve 11 sleeves on the bearing sleeve 13. As a result, the reciprocating sleeve 11 moves back and forth with respect to the bearing sleeve 13.

While the invention has been described in terms of preferred embodiments, those skilled in the art will recognize that the invention can be practiced with modifications within the spirit and scope of the appended claims.

What is claimed is:

1. A percussive massage gun comprising:
a first shell;
a second shell secured to the first shell for form a triangular handle chamber, a head chamber, and a ball-shaped components chamber formed between the handle and the head chamber;
three rechargeable batteries disposed in three parts of the handle chamber respectively and electrically connected together;
an electric motor disposed in the components chamber;
a cam disposed on a motor shaft of the electric motor and including a main body and an eccentric, cylindrical rod extending out of the main body;
a linkage disposed in the components chamber and including a first hole and a second hole;
a first bearing disposed on the eccentric, cylindrical rod and further inserted in the second hole of the linkage;
a second bearing disposed in the first hole of the linkage and being smaller than the first bearing;
a bearing seat disposed in a joining portion of the components chamber and the head chamber;
a bearing sleeve disposed in the head chamber;
a reciprocating sleeve engaged with the second bearing and passing through the bearing seat to put on the bearing sleeve;
an on/off switch disposed on an outer surface of the components chamber; and
a controller disposed in the components chamber and wherein the controller is adjacent to the on/off switch and electrically connected to the electric motor, the rechargeable batteries, and the on/off switch.

2. The percussive massage gun of claim 1, wherein the parts of the handle chamber are curved.

3. The percussive massage gun of claim 1, wherein the components chamber comprises a charging socket electrically connected to the rechargeable batteries.

4. The percussive massage gun of claim 3, wherein the charging socket is USB Type-C.

5. The percussive massage gun of claim 1, wherein the components chamber comprises a flange configured to secure the electric motor to the second shell.

6. The percussive massage gun of claim 5, further comprising a shock absorbing member sandwiched by the electric motor and the flange.

7. The percussive massage gun of claim 1, wherein the rechargeable batteries are electrically connected together in series.

8. The percussive massage gun of claim 1, wherein the first shell and the second shell are threadedly secured together.

9. The percussive massage gun of claim 1, further comprising a plurality of limit bars in the component chamber and spaced from two sides of the linkage.
